(19) United States
(12) Patent Application Publication
(10) Pub. No.: US 2007/0072656 A1
(43) Pub. Date: Mar. 29, 2007

(54) FOLDABLE ELECTRONIC DEVICE

(76) Inventors: Chien-Sheng Lo, Taipei (TW); Hung-Cheng Lee, Taipei (TW); Yu-Yuan Chen, Taipei (TW); Ying-Chi Chou, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/309,356

(22) Filed: Jul. 31, 2006

(30) Foreign Application Priority Data
Aug. 16, 2005 (TW) 94127841

(51) Int. Cl. H04M 1/00

(52) U.S. Cl. 455/575.3

(57) ABSTRACT

A foldable electronic device includes a first body, a second body, a magnetism sensing element and a rotation element. The second body is pivoted on one side of the first body. The magnetism sensing element is disposed inside the first body. The rotation element is disposed inside the second body and includes at least a magnet. When the distance between the magnetism sensing element and the rotation element is equal to or smaller than a first distance, the rotation element rotates to a first angle. When the distance between the magnetism sensing element and the rotation element is greater than the first distance, the rotation element rotates to a second angle, so that a user could open or close the foldable electronic device.

### CROSS-REFERENCE TO RELATED APPLICATION

This application claims the priority benefit of Taiwan application serial no. 94127841, filed on Aug. 16, 2005. All disclosure of the Taiwan application is incorporated herein by reference.

### BACKGROUND OF THE INVENTION

1. Field of the Invention

The present invention relates to a foldable electronic device. More particularly, the present invention relates to a foldable electronic device that opens and closes with a magnetism material.

2. Description of Related Art

With the development of electronic technology, to further follow the trend of portable and practical designs, the electronic devices in the current market are made light, thin, short and small to fit the life style of the modern society. The electronic devices are such as notebook computers, personal digital assistants (PDAs), electronic dictionaries or mobile phones. In order to make these electronic devices portable, they are generally made in a foldable structure so as to save space. In general, a foldable electronic device can be divided into two segments, namely, host body and display. The two segments are connected via a pivot. The detailed structure of the foldable electronic devices is illustrated below with the example of a notebook computer.

FIG. 1 is a three-dimensional drawing of a traditional notebook computer. Referring to FIG. 1, the notebook computer 100 includes a display 110 and a host body 120. The display 110 pivots on one side of the host body 120 and can rotate relative to the host body 120, so that the notebook computer 100 can be opened and closed. The display 110 further includes a latch hook 112 and a release button 114, and the host body 120 further includes a receptacle 122 corresponding to the latch hook 112. For closing the notebook computer 100, a user needs to fold down the display 110 to make the latch hook 112 directly slide into the receptacle 122 and lock thereon, so that the notebook computer 100 can be fully closed. On the other hand, for opening the notebook computer 100, the user can operate the release button 114 to free the latch hook 112 from the receptacle 122, thereby to open the notebook computer 100.

Although the design of the aforementioned latch hook 112 and receptacle can easily reach the goal of opening and closing the notebook computer 100, the design of the latch mechanism affects the whole aesthetic feeling of the notebook computer 100 when the notebook computer 100 is opened and the latch hook 112 on the display 110 is exposed. Besides, a user has to apply force to shift the release button 114 in order to open or close the notebook computer 100, which causes inconvenient in operation. Further, since the latch hook 112 is disposed on the inner surface of the display 110 without protection means, and inappropriate operation may cause damage to the notebook computer 100 in the long run, so that the notebook computer 100 may not open and close properly.

FIG. 2 is another schematic three-dimensional drawing of a traditional notebook computer. Referring to FIG. 2, the notebook computer 200 includes a display 210 and a host body 220 pivoted on one side of the display 210. The display 210 includes a magnet 212 corresponding to an iron plate 222 disposed in the host body 220. When a user folds down the display 110, if the distance between the magnet 212 and the iron plate 222 is short enough, the magnet 212 and the iron plate 222 are attracted by magnetic force, such that the notebook computer 200 is closed. On the other hand, when the user wants to open the notebook computer 200, the user just applies a force up the display 210 outside the part pivoted on the host body 220. However, in the design using the aforementioned magnet 212 and iron plate 222 to open or close the notebook computer 200, since the magnet 212 is set only on the side facing the host body 220 in the display 210, the design cannot be used in a convertible NB.

### SUMMARY OF THE INVENTION

Accordingly, the present invention is directed to provide a foldable electronic device so as to tightly close by way of magnetism.

According to an embodiment of the claimed invention, a foldable electronic device is disclosed. The foldable electronic device includes a first body, a second body, a magnetism sensing element and a rotation element. The second body is pivoted on one side of the first body. The magnetism sensing element is disposed inside the first body. The rotation element is disposed inside the second body and includes at least a magnet. When the distance between the magnetism sensing element and the rotation element is equal to or smaller than a first distance, the rotation element rotates to a first angle. When the distance between the magnetism sensing element and the rotation element is greater than the first distance, the rotation element rotates to a second angle. Thus, a user can open or close the foldable electronic device.

In an embodiment of the present invention, the rotation element further includes a first pivoting part and the second body further includes a second pivoting part. Wherein, being a rotation axis, the first pivoting part is disposed on one side of the rotation element. The second pivoting part has a hole. Besides, the foldable electronic device further includes at least one spring element disposed on the rotation axis. When the distance between the magnetic sensing element and the rotation element is greater than the first distance, the spring element pushes the rotation element to rotate to the second angle.

In an embodiment of the present invention, the difference between the first angle and the second angle is 90°.

In an embodiment of the present invention, when the first body and the second body are closed, the rotation element rotates to the first angle; when the first body and the second body are opened to an angle greater than a third angle, the rotation element rotates to the second angle.

In an embodiment of the present invention, the rotation element is a housing which has a receiving face and a number of sealing faces. Wherein, the receiving face is used to put the aforementioned magnet and the sealing faces are used to cover the magnet. Besides, the first body further has a first surface and the second body further has a second surface. When the first body and the second body are closed, the first surface is parallel to the second surface. Further more, when the rotation element rotates to the first angle, the receiving face is parallel to the second surface, then the magnet faces the second surface; when the rotation element rotates to the second angle, the receiving face is vertical to the second surface.

In an embodiment of the present invention, the magnetism sensing element is an iron plate with a material standard of S10C.

In the foldable electronic device of the present invention, the user does not need to touch any other switch device when opening or closing the foldable electronic device because of the arrangement of the magnetic rotation element, so it is comparatively convenient to use.

In order to make the aforementioned and other objects, features and advantages of the present invention comprehensible, preferred embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic drawing illustrating a traditional notebook computer.

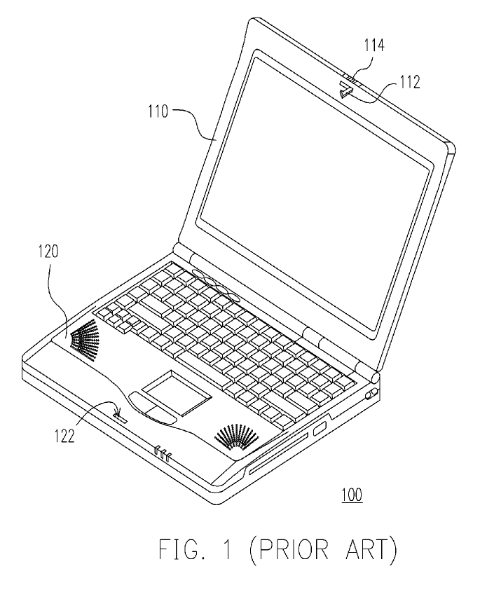

FIG. 2 is a schematic drawing illustrating another traditional notebook computer.

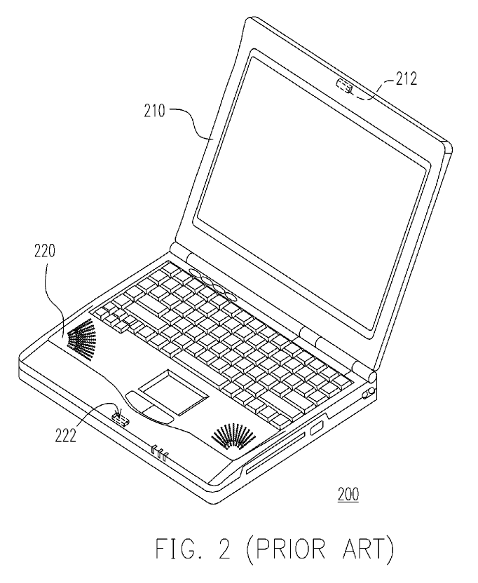

FIG. 3A is a schematic side view of a closed foldable electronic device according to an embodiment of the present invention.

FIG. 3B is a schematic side view of an open foldable electronic device according to an embodiment of the present invention.

FIG. 4 is a partial exploded drawing of a foldable electronic device of an embodiment of the present invention.

FIG. 5A is a partial exploded drawing of a closed foldable electronic device according to an embodiment of the present invention.

FIG. 5B is a partial exploded drawing of an open foldable electronic device according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

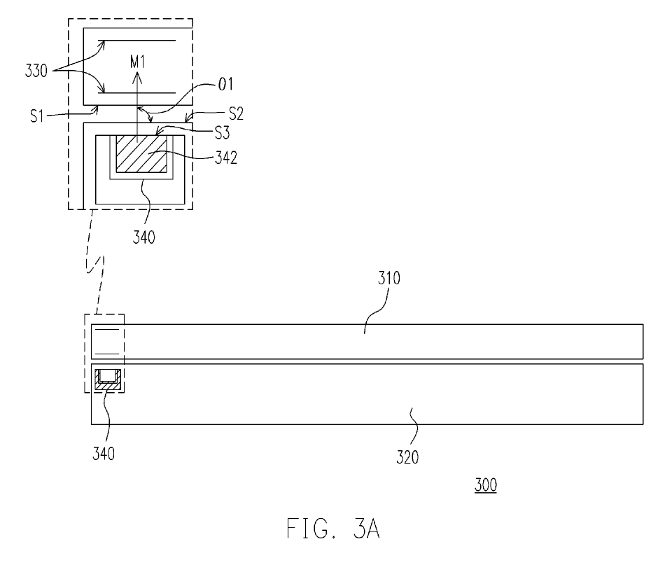

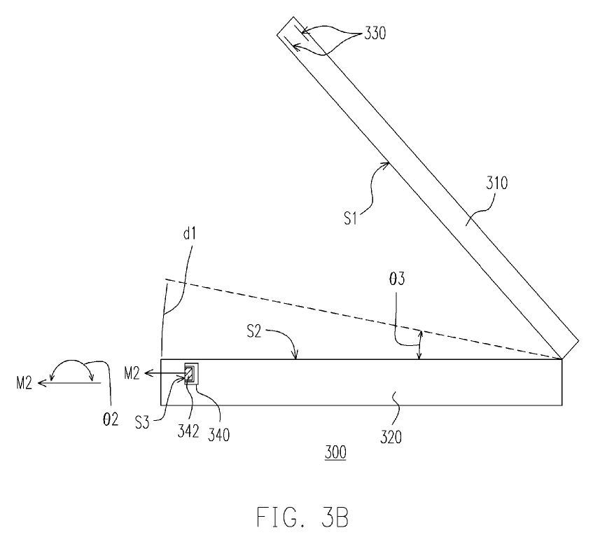

Please refer to FIG. 3A and FIG. 3B to depict the operation of the foldable electronic device, wherein FIG. 3A is a schematic side view of a closed foldable electronic device according to an embodiment of the present invention, and FIG. 3B is a schematic side view of an opened foldable electronic device according to an embodiment of the present invention. Referring to FIG. 3A. As shown in FIG. 3A, the foldable electronic device 300 includes a first body 310, a second body 320, a magnetism sensing element 330 and a rotation element 340. The first body 310 has a first surface S1 next to one side of the second body 320. The second body 320 is pivoted on one side of the first body 310 so that the first body 310 can be opened or closed relative to the second body 320. Furthermore, the second body 320 has a second surface S2 next to one side of the first body 310. The magnetism sensing element 330 is disposed inside the first body 310 to induce magnetic force, but not disposed in an area where the first body 310 and the second body 320 are pivoted. The rotation element 340 is disposed inside the second body 320 and can rotate relative to the second body 320. In addition, the rotation element 340 includes a magnet 342 inside corresponding to the magnetic sensing element 330 disposed inside the first body 310.

Referring to FIG. 3A, when the first body 310 and the second body 320 of the foldable electronic device 300 are closed, the magnet 342 in the rotation element 340 is attracted by the magnetism sensing element 330 so that the rotation element 340 rotates to a position parallel to the second surface S2, thereby tightly closing the foldable electronic device 300 by way of the attraction between the magnet 342 and the magnetism sensing element 330. Here the rotation element 340 is located at a first angle θ1, which is the angle between the magnetic force direction M1 of the magnet 342 and the second surface S2 of the second body 320. In this embodiment, the first angle θ1 is 90°, since the angle between the magnetic force direction M1 and the second surface S2 is 90°.

Referring to FIG. 3B, when the foldable electronic device 300 is opened and the distance between the magnetism sensing element 330 of the first body 310 and the rotation element 340 of the second body 320 is greater than a first distance d1, the rotation element 340 rotates and is orthogonal to the second surface S2 since the attraction between the magnet 342 and the magnetism sensing element 330 weakens. Here, the rotation element 340 is located at a second angle θ2, which is the angle between the magnetic force direction M2 of the magnet 342 and the second surface S2 of the second body 320. In this embodiment, the second angle θ2 is 180°, since the angle between the magnetic force direction M2 and the second surface S2 is 180°. As shown in FIG. 3A and FIG. 3B, the difference between the first angle θ1 and the second angle θ2 is 90°. Besides, in the embodiment, the first distance d1 corresponding to the place where the first body 310 and the second body 320 are pivoted further forms a third angle θ3.

Accordingly, for opening or closing the foldable electronic device 300, the first body 310 can be rotated relative to the second body 320 to be opened or closed without touching any other switch device, such as a release button. Namely, the foldable electronic device 300 can be opened or closed by way of the attraction between the magnet 342 of the rotation element 340 and the magnetism sensing element 330. Thus, it is comparatively convenient for users to operate. Furthermore, because the magnetism sensing element 330 is disposed in the first body 310 without exposing and the rotation element 340 is disposed in the second body 320 without exposing, the whole aesthetic feeling of the foldable electronic device 300 can be improved.

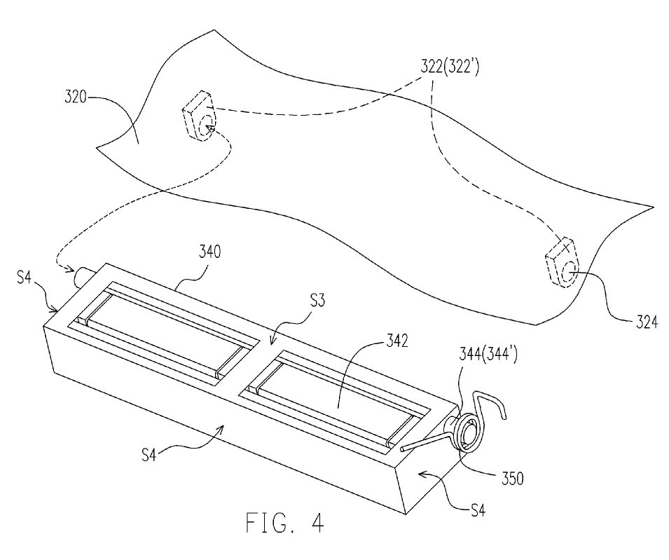

FIG. 4 is a partial exploded drawing of a foldable electronic device of the preferred embodiment of the present invention. Referring to FIG. 4, the rotation element 340 is a housing capable of containing the aforementioned magnet 342. The rotation element 340 includes a first pivoting part 344, a receiving face S3 and a number of sealing faces S4. The first pivoting part 344 is disposed on two sides of the housing so that the rotation element 340 can rotate relative to the second body 320. In this embodiment, the first pivoting part 344 is a pair of axes of rotation 344′. The receiving face S3 of the rotation element 340 is used for accommodating the magnet 342. The sealing faces S4 are used for covering the magnet 342. It should be note that the main magnetic force direction of the magnet 342 is vertical to the receiving face S3, so that the magnetic force right in front of the receiving face S3 is strongest, and gradually weakens along with the increase of the distance.

Furthermore, the second body 320 of the foldable electronic device 300 further includes a second pivoting part 322 to be pivoted with the rotation element 340. In this embodiment, the second pivoting part 322 is a pair of bearings 322′, on which a hole 324 is disposed respectively. Furthermore, the axes of rotation 344′ on two sides of the rotation element 340 are disposed through the holes 324, so that the rotation element 340 can rotate relative to the second body 320.

It should be note that the foldable electronic device 300 further includes a spring element 350 disposed on the axes of rotation 344′ of the rotation element 340. As shown in FIG. 3B and FIG. 4, when the distance between the magnetism sensing element 330 and the rotation element 340 is greater than the first distance d1, because the attraction between the magnet 342 and the magnetism sensing element 330 weakens, the rotation element 340 can be pushed to rotate to the second angle θ2 by the spring force of the spring element 350. In this embodiment, the spring element 350 may be a torsion spring.

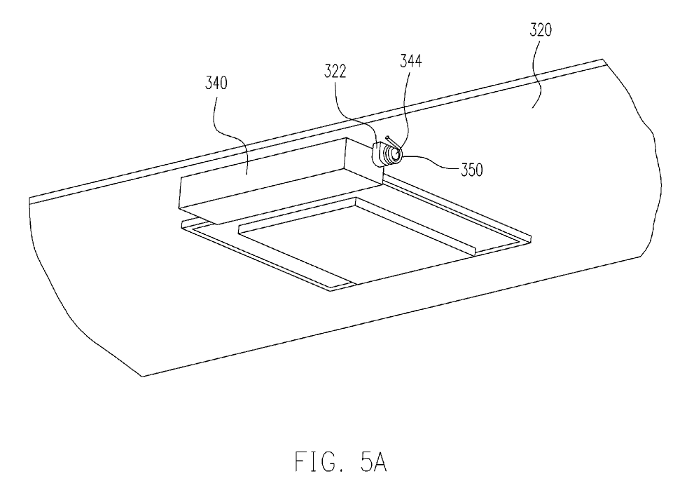

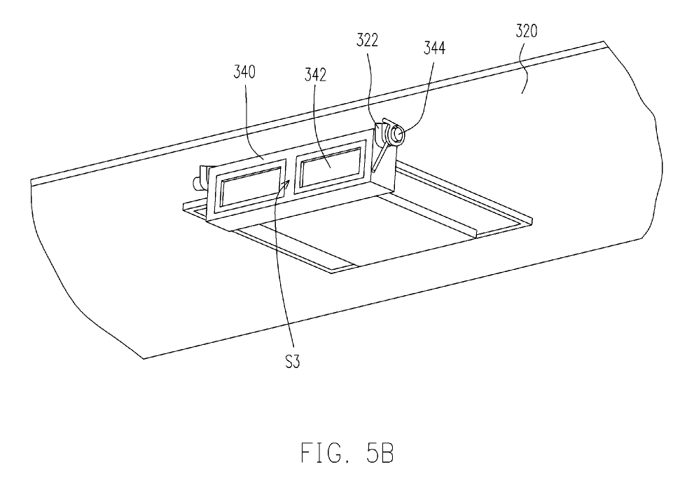

FIG. 5A is a three-dimensional drawing of the rotation element in the second body when the foldable electronic device of the preferred embodiment of the present invention is closed. Referring to FIG. 3A and FIG. 5A, when the first body 310 and the second body 320 are closed, the first surface S1 is parallel to the second surface S2 and the rotation element 340 rotates to the first angle θ1. Here, the receiving face S3 of the rotation element 340 is parallel to the second surface S2, such that the magnet 342 in the rotation element 340 faces the second surface S2 and is attracted to the magnetism sensing element 330, thereby tightly closing the foldable electronic device 300. Of course, the attraction between the magnet 342 and the magnetism sensing element 330 should not be overly strong but just appropriate for common users to open. In addition, when the main magnetic force direction M1 of the magnet 342 passes through the receiving face S3, the magnetism sensing element 330 is capable of obstructing the magnet force. Therefore, when a user mistakenly puts a magcard on the foldable electronic device 300, the magcard can be prevented from being demagnetized. Also, as shown in FIG. 3A, when the foldable electronic device 300 provided by the preferred embodiment of the present invention is a convertible foldable electronic device, since the first body 310 can be reversed and thus its two surfaces can both be closed with the second body 320, two magnetism sensing elements 330 can be disposed respectively close to two surfaces of the first body 310. In this embodiment, the magnetism sensing element 330 is an iron plate, such as a plate-shaped high ferruginous material, i.e., a S10C material, but the present invention is not limited to it.

FIG. 5B is a partial exploded drawing of an opened foldable electronic device according to an embodiment of the present invention. Referring to FIG. 3B and FIG. 5B, when a user opens the foldable electronic device 300 and the angle between the first body 310 and the second body 320 is greater than the third angle θ3, namely, the distance between the magnetism sensing elements 330 and the rotation element 340 is greater than the first distance d1, because the attraction between the magnet 342 and the magnetism sensing elements 330 weakens, the rotation element 340 is rotated so that the receiving face S3 of the rotation element 340 is vertical to the second face S2. Here, the main magnetic force of the magnet 342 passes through the receiving face S3 and sends out horizontally. Hence, the magcard can be prevented from being demagnetized since it is not in the main magnet force area when a user mistakenly puts a magcard on the second body 302.

In summary, according to the foldable electronic device of the preferred embodiment of the present invention, the magnetism sensing element and the magnet are both disposed inside the electronic device, so that the aesthetic feeling of the foldable electronic device can be improved. Besides, without the arrangement of the latch hook structure, the user just opens the lid without touching any switch element when opening the foldable electronic device, so that it is comparatively convenient to use. Further, in the preferred embodiment of the present invention, since the magnet is disposed in a rotation element which automatically adjusts its position according to the opening or closing state of the foldable electronic device, the magcards can be prevented from being demagnetizing.

The present invention is disclosed above with its preferred embodiment. It is to be understood that the preferred embodiment of present invention is not to be taken in a limiting sense. It will be apparent to those skilled in the art that various modifications and variations can be made to the structure of the present invention without departing from the scope or spirit of the invention. The protection scope of the present invention is in accordant with the scope of the following claims and their equivalents.

What is claimed is:

1. A foldable electronic device, comprising:
a first body;
a second body, pivoted on one side of the first body;
a magnetism sensing element, disposed inside the first body; and
a rotation element, pivoted inside the second body and including at least one magnet therein;
when the distance between the magnetic sensing element and the rotation element is equal to or smaller than a first distance, the rotation element rotates to a first angle;
when the distance between the magnetism sensing element and the rotation element is greater than the first distance, the rotation element rotates to a second angle.

2. The foldable electronic device as claimed in claim 1, wherein the rotation element further includes a first pivoting part and the second body further includes a second pivoting part, the first pivoting part being pivoted on the second pivoting part.

3. The foldable electronic device as claimed in claim 2, wherein the first pivoting part disposed on one side of the rotation element serves as a rotation axis, and the second pivoting part has a hole.

4. The foldable electronic device as claimed in claim 2, further comprising at least one spring element disposed on the first pivoting part; when the distance between the magnetism sensing element and the rotation element is greater than the first distance, the spring element pushes the rotation element to rotate to the second angle.

5. The foldable electronic device as claimed in claim 1, wherein the difference between the first angle and the second angle is 90°.

6. The foldable electronic device as claimed in claim 1, wherein when the first body and the second body are closed, the rotation element rotates to the first angle; when the first body and the second body are opened to an angle greater than a third angle, the rotation element rotates to the second angle.

7. The foldable electronic device as claimed in claim 1, wherein the rotation element is a housing with a plurality of sealing faces for covering the magnet and a receiving face for accommodating the magnet.

8. The foldable electronic device as claimed in claim 7, wherein the first body further has a first surface and the second body further has a second surface; when the first body and the second body are closed, the first surface is parallel to the second surface; when the rotation element rotates to the first angle, the receiving face is parallel to the second surface, and then the magnet faces the second surface; when the rotation element rotates to the second angle, the receiving face is vertical to the second surface.

9. The foldable electronic device as claimed in claim 1, wherein the magnetism sensing element is an iron plate.

10. The foldable electronic device as claimed in claim 9, wherein the material standard of the iron plate is S10C.
